(19) United States
(12) Patent Application Publication
(10) Pub. No.: US 2013/0220973 A1
(43) Pub. Date: Aug. 29, 2013

(54) PROCESS FOR MANUFACTURING GLASS HARD DISC SUBSTRATES

(71) Applicants: Haruhiko Doi, New York, NY (US); Nobuyuki Aono, Wakayama-shi (JP)

(72) Inventors: Haruhiko Doi, New York, NY (US); Nobuyuki Aono, Wakayama-shi (JP)

(73) Assignee: KAO CORPORATION, Tokyo (JP)

(21) Appl. No.: 13/881,992

(22) PCT Filed: Oct. 26, 2011
(86) PCT No.: PCT/JP2011/074694

§ 371 Date: Apr. 26, 2013

(30) Foreign Application Priority Data
Oct. 27, 2010 (JP) 2010-241063
Oct. 25, 2011 (JP) 2011-234183

(51) Int. Cl. C03C 15/02

(52) U.S. Cl. CPC C03C 15/02
USPC 216/53

(57) ABSTRACT

Provided is a method for producing a glass hard disk substrate, including steps of polishing a glass substrate with an acidic polishing liquid; and subjecting the obtained substrate to alkali cleaning. This method can inhibit degradation of surface roughness of the glass substrate in the alkali cleaning step while maintaining a polishing rate in the polishing step, and further can improve cleanliness.

The method for producing a glass hard disk substrate includes the following steps (1) and (2):
(1) polishing a glass substrate to be polished using a polishing composition of pH 1.0-4.2 that contains a polyvalent amine compound having 2 to 10 nitrogen atoms in the molecule; and
(2) cleaning the substrate obtained in the step (1) using a cleaner composition of pH 8.0-13.0.

### TECHNICAL FIELD

The present invention relates to a method for producing a glass hard disk substrate.

### BACKGROUND ART

Hard disks installed in a hard disk drive rotate at a high speed, and hence consume much electric power. Recently, for environmental considerations, reduction of power consumption is demanded. In order to reduce the power consumption, recording capacity of one hard disk is increased and the number of the hard disks to be installed in a drive is decreased for weight reduction. For reducing the weight of each substrate, it is required to reduce the thickness of the substrate. From this viewpoint, a demand for glass substrates having higher mechanical strength than aluminum substrates has been increasing and developing significantly in recent years. Further, for enhancing the recording capacity of one substrate, it is required to reduce the unit recording area. However, when the unit recording area is reduced, a problem occurs, namely, magnetic signals are weakened. For enhancing the detection sensitivity for the magnetic signals, a technology of further lowering the flying height of a magnetic head is developed. In polishing a glass hard disk substrate, for corresponding to the trend of lowering the flying height of a magnetic head, a demand for decreasing surface roughness and residues have become severer. In response to such a demand, a technology of polishing a glass substrate with an acidic polishing composition has been proposed (for example, see Patent Document 1).

A method of polishing a glass substrate with an acidic polishing composition brings the following advantage. Alkali ions contained in a glass substrate are eluted during polishing, i.e., leaching action occurs, and the hardness of the substrate surface is decreased, thereby enhancing the polishing rate. However, in the method of polishing a glass substrate with an acidic polishing composition, strong leaching action occurs when the pH is low, which generates a deep weak leaching layer and degrades surface roughness significantly due to alkaline etching in an alkali cleaning step after a polishing step. To cope with such a problem, in order to enhance the polishing rate while inhibiting generation of a leaching layer, a method of polishing a glass substrate with a weakly acidic (pH 4-6) polishing liquid that contains an additive for increasing an electrolytic concentration of the polishing liquid has been proposed (for example, see Patent Document 2).

Patent Document 3 proposes a glass substrate for a magnetic disk that has significantly few defects on the front surface in the vicinity of 0.1 nm of an arithmetic average roughness (Ra). As additives of a polishing liquid used in the production, Patent Document 3 discloses carboxylic acids, polyvalent amine, amino acids, amino polycarboxylic acids, phosphonic acids, etc. It also discloses that, by these additives, abrasives can keep interacting with the surface of the glass substrate in the form of the secondary aggregation, and thus foreign substances can be removed from the glass substrate.

### PRIOR ART DOCUMENTS

### Patent Documents

[Patent Document 1] JP 2005-138197 A
[Patent Document 2] JP 2009-087439 A
[Patent Document 3] WO 2010/038741

### DISCLOSURE OF INVENTION

### Problem to be Solved by the Invention

However, in the method described in Patent Document 2, since the glass substrate is polished with a weakly acidic polishing composition, the polishing rate is slow and the productivity is low. Also in the method described in Patent Document 3, a satisfactory polishing rate cannot be obtained.

Therefore, the present invention provides, in a method for producing a glass hard disk substrate that includes steps of polishing a glass substrate with an acidic polishing liquid; and subjecting the obtained substrate to alkali cleaning, a method for producing a glass hard disk substrate capable of inhibiting degradation of surface roughness of the glass substrate in the alkali cleaning step while maintaining a polishing rate in the polishing step and further capable of improving cleanliness.

### Means for Solving Problem

The present invention relates to a method for producing a glass hard disk substrate that includes the following steps (1) and (2):

(1) polishing a glass substrate to be polished using a polishing composition of pH 1.0-4.2 that contains a polyvalent amine compound having 2 to 10 nitrogen atoms in the molecule; and

(2) cleaning the substrate obtained in the step (1) using a cleaner composition of pH 8.0-13.0.

### Effect of the Invention

According to the present invention, it is possible to effectively inhibit degradation of surface roughness of the glass substrate in the alkali cleaning step while maintaining a polishing rate in the polishing step, and further to improve cleanliness.

### DESCRIPTION OF THE INVENTION

The present invention is based on the finding that, even when a glass substrate is polished with an acidic polishing liquid and the obtained substrate is subjected to alkali cleaning, it is possible to inhibit degradation of surface roughness of the glass substrate due to alkali cleaning while maintaining a polishing rate using an acidic polishing liquid and further to improve cleanliness, if the polishing liquid contains a polyvalent amine compound.

In other words, in one aspect, the present invention relates to a method for producing a glass hard disk substrate (hereinafter, also referred to as “substrate producing method of the present invention”) that includes the following steps (1) and (2):

(1) polishing a glass substrate to be polished using a polishing composition of pH 1.0-4.2 that contains a polyvalent amine compound having 2 to 10 nitrogen atoms in the molecule; and

(2) cleaning the substrate obtained in the step (1) using a cleaner composition of pH 8.0-13.0.

Although the reason is unclear why the polishing rate in the polishing step is maintained by the substrate producing method of the present invention, it is considered as follows. When the number of nitrogen atoms of the polyvalent amine compound is in a specified range, adsorbability of the polyvalent amine compound with respect to the substrate is adjusted suitably and the polyvalent amine compound is adsorbed on a surface of the glass substrate. Thus, leaching action is inhibited and the polishing rate is maintained.

Further, although the reason is unclear why degradation of surface roughness in the alkali cleaning step is inhibited effectively, it is considered as follows. Since the polyvalent amine compound adsorbed on the surface of the glass substrate in the polishing step inhibits elution of alkali ions in the glass substrate, generation of a weak leaching layer is inhibited. Thus, degradation of surface roughness in the alkali cleaning step is inhibited.

Generally, the glass hard disk substrate is produced through steps starting with a step of obtaining a glass base by mold-pressing of molten glass or cutting-off from sheet glass, followed by a profiling step, an edge polishing step, a rough-grinding step, a fine-grinding step, a rough-polishing step, a final-polishing step and a chemical strengthening step. The chemical strengthening step may be performed before the final-polishing step. A cleaning process may be interposed between the respective steps. The glass hard disk substrate becomes a magnetic hard disk after experiencing a step of forming a recording portion.

[Glass Substrate]

The substrate to be polished that is subjected to polishing and the substrate after polishing that is subjected to cleaning in the substrate producing method of the present invention are a glass substrate. Examples of the glass substrates include glasses that contain metallic atoms other than Si, such as aluminosilicate glass, borosilicate glass, aluminoborosilicate glass, and aluminosilicate glass whose sodium is substituted by potassium in a chemical strengthening step. In terms of improving the polishing rate, an aluminosilicate glass substrate and an aluminosilicate glass substrate whose sodium is substituted by potassium in a chemical strengthening step are preferred, and an aluminosilicate glass substrate is more preferred. The aluminosilicate glass substrate contains Si the most other than 0 (oxygen) as the constituent element, which is followed by Al (aluminum) and Na (sodium). Generally, Si content is 20 to 40 wt %, Al content is 3 to 25 wt %, Na content is 3 to 25 wt %, and K, Ti, Zn, S, Ca, P, B, Zr, Fe, Sr, Nb, Ba, Ni and the like also may be contained. In the case of using an aluminosilicate glass substrate for a hard disk, in terms of improving the polishing rate and maintaining the translucency of the substrate, the Al content is preferably 5 to 20 wt % and more preferably 7 to 15 wt %, and the Na content is preferably 3 to 20 wt % and more preferably 5 to 15 wt %. The Al content and the Na content contained in the aluminosilicate glass substrate are calculated by the method described in Examples.

[Polishing Composition]

The substrate producing method of the present invention includes a step of polishing a glass substrate using a polishing composition, and the polishing composition contains at least a polyvalent amine compound having 2 to 10 nitrogen atoms in the molecule (hereinafter, also referred to as “polyvalent amine compound”).

It is preferred that the polishing composition further contains polishing abrasive grains, acid and water.

[Polyvalent Amine Compound]

It is considered that leaching action in the acidic polishing can be inhibited in the following manner. As the number of nitrogen atoms contained in the polyvalent amine compound blended in the polishing composition increases, adsorption points increase, whereby the polyvalent amine compound can be adsorbed on the glass hard disk substrate strongly. Meanwhile, when the number of nitrogen atoms of the polyvalent amine compound is excessive, the polyvalent amine compound is adsorbed on the glass substrate too strongly, which decreases the polishing rate. That is, in order to improve the polishing rate while inhibiting leaching action at the time of the acidic polishing, the polyvalent amine compound should contain the optimum number of nitrogen atoms. Note here that the present invention is not limited to these assumptions.

In terms of maintaining the polishing rate, the number of nitrogen atoms contained in the polyvalent amine compound that is used in the polishing composition of the present invention is 10 or less, preferably 8 or less, more preferably 6 or less, further preferably 5 or less, and further more preferably 4 or less. In terms of inhibiting the degradation of surface roughness in the cleaning step, the number of nitrogen atoms is 2 or more. Therefore, in terms of maintaining the polishing rate and inhibiting the degradation of surface roughness in the cleaning step, the number of nitrogen atoms contained in the polyvalent amine compound is 2 to 10 in the molecule, preferably 2 to 8, more preferably 2 to 6, further preferably 2 to 5, and further more preferably 2 to 4.

Further, the substrate producing method of the present invention can improve cleanliness of the glass substrate. Although the reason is unclear, it is considered as follows. The polyvalent amine compound is adsorbed on the surface of the glass substrate and thus the substrate surface assumes a positive charge. The polyvalent amine compound is adsorbed also to materials remaining on the substrate after polishing (silica particles, glass debris, etc.) and thus they assume a positive charge. As a result, repulsion is generated between the glass substrate and the residues, thereby developing an effect of suppressing adsorption of residues.

In terms of improving the cleanliness, the number of nitrogen atoms contained in the polyvalent amine compound that is used in the polishing composition of the present invention is 2 or more, and preferably 3 or more. Therefore, in terms of obtaining the cleanliness while maintaining the polishing rate, the number of nitrogen atoms contained in the polyvalent amine compound is preferably 2 to 8, more preferably 2 to 6, further preferably 2 to 5, further more preferably 3 to 5, and further more preferably 3 to 4.

Further, in terms of maintaining the polishing rate, a molecular weight of the polyvalent amine compound is preferably 500 or less, more preferably 400 or less, further preferably 300 or less, and further more preferably 200 or less. In terms of inhibiting the degradation of surface roughness in the cleaning step and further improving the cleanliness, the molecular weight is preferably 40 or more, more preferably 50 or more, further preferably 60 or more, further more preferably 100 or more, and further more preferably 150 or more. Therefore, in terms of maintaining the polishing rate, inhibiting the degradation of surface roughness in the cleaning step, and further improving the cleanliness, the molecular weight is preferably 500 or less, more preferably 40 to 500, further preferably 50 to 500, further more preferably 50 to 400, further more preferably 60 to 300, further more preferably 100 to 300, and further more preferably 150 to 200. One or plural kinds of the polyvalent amine compound may be contained in the polishing composition. Further, the polyvalent amine compound may be in the form of salt, and the examples include salts of inorganic acids such as hydrochloric acid, sulfuric acid, phosphoric acid and the like, organic acids and the like, and anionic surfactants.

Specific examples of the polyvalent amine compound include ethylenediamine, diethylenetriamine, triethylenetetramine, tetraethylenepentamine, pentaethylenehexamine, 2-[(2-aminoethyl)amino]ethanol, 2-[methyl[2-(dimethylamino)ethyl]amino]ethanol, 2,2′-(ethylenebisimino)bisethanol, N-(2-hydroxyethyl)-N′-(2-aminoethyl)ethylenediamine, 2,2′-(2-aminoethylimino)diethanol, N1,N4-bis(hydroxyethyl)diethylenetriamine, N1,N7-bis(hydroxyethyl)diethylenetriamine, 1,3-diamino-2-propanol, piperazine, 1-methylpiperazine, 3-(1-piperazinyl)-1-propaneamine, 1-(2-aminoethyl)piperazine, 4-methylpiperazine-1-amine, 1-piperazinemethaneamine, 4-ethyl-1-piperazineamine, 1-methyl-4-(2-aminoethyl)piperazine, and 1-(2-hydroxyethyl)piperazine. In terms of maintaining the polishing rate, inhibiting the degradation of surface roughness in the cleaning step, and improving the cleanliness, 2-[(2-aminoethyl)amino]ethanol, 1-(2-aminoethyl)piperazine, 1-(2-hydroxyethyl)piperazine, diethylenetriamine, and triethylenetetramine are preferred; 2-[(2-aminoethyl)amino]ethanol, 1-(2-aminoethyl)piperazine, 1-(2-hydroxyethyl)piperazine, and diethylenetriamine are more preferred; 2-[(2-aminoethyl)amino]ethanol, 1-(2-aminoethyl)piperazine, and diethylenetriamine are further preferred; and diethylenetriamine is further more preferred. Particularly, in terms of maintaining the polishing rate, 1-(2-hydroxyethyl)piperazine is preferred.

Further, as to the polyvalent amine compound, in terms of preventing odor generation caused by amine volatilization or the like and improving safety to workers, the vapor pressure at 25° C. is preferably 0.3 mmHg or lower, and more preferably 0.25 mmHg or lower. Examples of such polyvalent amine compounds include 2-[(2-aminoethyl)amino]ethanol, 1-(2-hydroxyethyl)piperazine, 1-(2-aminoethyl)piperazine, diethylenetriamine, triethylenetetramine, tetraethylenepentamine, pentaethylenehexamine. From the same viewpoint, 2-[(2-aminoethyl)amino]ethanol, 1-(2-hydroxyethyl)piperazine, diethylenetriamine, triethylenetetramine, tetraethylenepentamine, and pentaethylenehexamine are preferred, and triethylenetetramine, tetraethylenepentamine, and pentaethylenehexamine are more preferred. Here, the vapor pressure at 25° C. indicates the pressure of a vapor phase that is in an equilibrium with a liquid phase or solid phase at a constant temperature. It is specified in Handbook of Chemical Compound Data for Process Safety (written by Carl L. Yaws, published by Gulf Publishing Company), or, CRC Handbook of Chemistry and Physics 88th Edition (written by Lide, D. R, (ed)).

In terms of maintaining the polishing rate and improving the cleanliness of the substrate, the content of the polyvalent amine compound in the polishing composition is preferably 5 wt % or less, more preferably 4 wt % or less, further preferably 3 wt % or less, further more preferably 1 wt % or less, further more preferably 0.5 wt % or less, and further more preferably 0.1 wt % or less. In terms of inhibiting the degradation of surface roughness in the cleaning step, improving the cleanliness of the substrate, and improving the polishing liquid durability in a recirculation polishing, the content of the polyvalent amine compound in the polishing composition is preferably 0.001 wt % or more, more preferably 0.005 wt % or more, and further preferably 0.01 wt % or more. Therefore, in terms of maintaining the polishing rate, inhibiting the degradation of surface roughness in the cleaning step, improving the cleanliness of the substrate, and improving the polishing liquid durability in a recirculation polishing, the content is preferably 0.001 to 5 wt %, more preferably 0.005 to 4 wt %, further preferably 0.01 to 3 wt %, further more preferably 0.01 to 1 wt %, further more preferably 0.01 to 0.5 wt %, and further more preferably 0.01 to 0.1 wt %. In the case where plural kinds of polyvalent amine compounds are contained in the polishing composition, the above-described content of the polyvalent amine compound indicates the total content of the all polyvalent amine compounds.

[Polishing Abrasive Grain]

In terms of improving the polishing rate, the polishing composition preferably contains polishing abrasive grains. Examples of the polishing abrasive grains used in the present invention include silica such as colloidal silica, fumed silica, surface-modified silica, or alumina, cerium oxide, etc. In terms of decreasing the surface roughness of the substrate and improving the cleanliness of the substrate, colloidal silica is preferred. Further, as the form of polishing abrasive grain in use, slurry is preferred.

The colloidal silica can be made from a silicate alkali metal salt such as sodium silicate by a water-glass method where the raw material is allowed to be subjected to a condensation reaction in an aqueous solution so as to grow the particles. Alternatively, the colloidal silica can be made from alkoxysilane such as tetraethoxysilane by an alkoxysilane method where the raw material is allowed to be subjected to a condensation reaction in water containing a water-soluble organic solvent such as alcohol so as to grow the particles. The fumed silica can be made from a volatile silicon compound such as silicon tetrachloride by a gas phase method where the raw material is hydrolyzed under a high temperature of 1000° C. or higher caused by an oxygen-hydrogen burner so as to grow the particles.

The average primary particle diameter of the polishing abrasive grain is preferably 5 to 200 nm, more preferably 7 to 100 nm, further preferably 9 to 80 nm, and further more preferably 10 to 50 nm in terms of improving the polishing rate, improving the cleanliness, and decreasing the surface roughness. Here, the average primary particle diameter of the polishing abrasive grain is measured by the method described in Examples.

The content of the polishing abrasive grain in the polishing composition is preferably 1 to 20 wt %, more preferably 2 to 19 wt %, further preferably 3 to 18 wt %, and further more preferably 5 to 16 wt % in terms of improving the polishing rate and decreasing the surface roughness.

[Acid]

The polishing composition preferably contains an acid in terms of improving the polishing rate. Examples of the acids to be used include: inorganic acids such as nitric acid, sulfuric acid, sulfurous acid, persulfuric acid, hydrochloric acid, perchloric acid, phosphoric acid, phosphonic acid, phosphinic acid, pyrophosphoric acid, tripolyphosphoric acid, and amidosulfuric acid; sulfur-containing organic acids such as methanedisulfonic acid, ethanedisulfonic acid, phenoldisulfonic acid, and naphthalenedisulfonic acid; phosphorous organic acids such as 2-aminoethylphosphonic acid, 1-hydroxyethylidene-1,1-diphosphonic acid, aminotri(methylenephosphonic acid), ethylenediaminetetra (methylenephosphonic acid), diethylenetriaminepenta(methylenephosphonic acid), ethane-1,1,-diphosphonic acid, ethane-1,1,2-triphosphonic acid, ethane-1-hydroxy-1,1-diphosphonic acid, ethane-1-hydroxy-1,1,2-triphosphonic acid, ethane-1,2-dicarboxy-1,2-diphosphonic acid, methanehydroxyphosphonic acid, 2-phosphonobutane-1,2-dicarboxylic acid, 1-phosphonobutane-2,3,4-tricarboxylic acid, and α-methylphosphonosuccinic acid; carboxylic acids such as oxalic acid, succinic acid, glutaric acid, adipic acid, maleic acid, fumaric acid, itaconic acid, phthalic acid, nitrotriacetic acid, nitroacetic acid, ethylenediamine tetraacetic acid, and oxalacetic acid; organic carboxylic acids containing a hydroxyl group in the molecule such as malic acid, tartaric acid, citric acid, isocitric acid, and glycolic acid; and aminocarboxylic acids such as glutamic acid, picolinic acid and aspartic acid. Meanwhile, in terms of reducing a COD value that is a standard for water pollution caused by drainage in the substrate production, inorganic acids are preferred, and phosphoric acid and sulfuric acid are more preferred. Further, in terms of improving the polishing liquid durability in a recirculation polishing, at least one kind selected from polyvalent carboxylic acids, organic carboxylic acids containing a hydroxyl group in the molecule, phosphorous inorganic acids, and phosphorous organic acids are preferred; at least one kind selected from polyvalent carboxylic acids, organic carboxylic acids containing a hydroxyl group in the molecule, and phosphorous organic acids are more preferred; and polyvalent carboxylic acids, and organic carboxylic acids containing a hydroxyl group in the molecule are further preferred. Specifically, at least one kind selected from 1-hydroxyethylidene-1,1-diphosphonic acid, glycolic acid, succinic acid, malic acid, tartaric acid, and citric acid are preferred; at least one kind selected from 1-hydroxyethylidene-1,1-diphosphonic acid, glycolic acid, malic acid, and citric acid are more preferred; and at least one kind selected from glycolic acid, malic acid, and citric acid are further preferred in terms of availability. These compounds may be used singly or as a mixture of two or more.

The acid may be in the form of salt. In the case of using salts of these acids, there is no particular limitation. Specifically, salts of alkali metals, alkaline-earth metals, ammonium, alkyl ammonium and the like are used. Among them, in terms of improving the polishing rate and decreasing the roughness, salts of alkali metals or ammonium are preferred.

In terms of improving the polishing rate and improving the durability in a recirculation polishing, the content of the acid in the polishing composition is preferably 0.05 wt % or more, more preferably 0.1 wt % or more, and further preferably 0.15 wt % or more. For further suppressing corrosion of a polishing apparatus, the content of the acid is preferably 10 wt % or less, more preferably 7.5 wt % or less, further preferably 5.5 wt % or less, and further more preferably 2 wt % or less. Therefore, the content of the acid is preferably 0.05 to 10 wt %, more preferably 0.1 to 7.5 wt %, further preferably 0.15 to 5.5 wt %, and further more preferably 0.15 to 2 wt %. In the case where plural kinds of acids are contained in the polishing composition, the above-described content of the acid indicates the total content of the all acids.

In terms of maintaining the polishing rate, inhibiting the degradation of surface roughness in the cleaning step, improving the cleanliness, and improving the durability in a recirculation polishing, the weight ratio of the polyvalent amine compound to the acid (polyvalent amine compound weight/acid weight) in the polishing composition is preferably 0.001 to 1.0, more preferably 0.005 to 0.5, and further preferably 0.01 to 0.3.

[Water]

The polishing composition preferably contains water as a medium, and distilled water, ion-exchange water, pure water, ultrapure water and the like can be used. For further facilitating handling of the polishing composition, the content of the water in the polishing composition in the substrate producing method of the present invention is preferably 55 wt % or more, more preferably 70 wt % or more, further preferably 80 wt % or more, and particularly preferably 85 wt % or more. In terms of improving the polishing rate, the content of the water is preferably 99 wt % or less, more preferably 98 wt % or less, and further preferably 97 wt % or less. Therefore, the content of the medium is preferably 55 to 99 wt %, more preferably 70 to 98 wt %, further preferably 80 to 97 wt %, and further more preferably 85 to 97 wt %.

[pH of Polishing Composition]

In terms of improving the polishing rate, decreasing the surface roughness in the alkali cleaning step, improving the durability in a recirculation polishing, preventing corrosion of a polisher, and improving the safety to workers, the pH of the polishing composition is 1.0 to 4.2, preferably 1 or more and less than 4.2, more preferably 1.5 to 4.0, further preferably 1.5 to 3.5, further more preferably 2.0 to 3.5, and further more preferably 2.5 to 3.5. Incidentally, the above-described pH is a pH of the polishing composition at 25° C., which can be measured using a pH meter (HM-30G manufactured by DKK-TOA CORPORATION) and indicates a numerical value taken 3 minutes after immersing an electrode in the polishing composition.

[Other Components]

The polishing composition further may contain a bactericide, an antibacterial agent, a thickener, a dispersant, an antirust agent and the like. In terms of the polishing property, the content of such components in the polishing composition is preferably 5 wt % or less, more preferably 3 wt % or less, and further preferably 1 wt % or less.

[Method for Preparing Polishing Composition]

The polishing composition can be prepared by mixing respective components using a known method. In terms of cost effectiveness, generally the polishing composition is produced in the form of a concentrated liquid and diluted in use. The polishing composition may be used directly, and a concentrated liquid may be diluted in use. When the concentrated liquid is diluted, the dilution rate is not particularly limited, and can be determined appropriately in accordance with the concentration of each component (e.g., the content of the abrasives) in the concentrated liquid, the polishing conditions, or the like.

The pH of the polishing composition may be adjusted to a predetermined value after mixing the components. Alternatively, the pH of each component may be adjusted separately before mixing. The pH adjustment can be carried out using pH adjusters for the polyvalent amine compound, the acid and the other components.

[Cleaner Composition]

The substrate producing method of the present invention includes a step of cleaning the glass substrate that has been polished using the polishing composition, using a cleaner composition of pH 8.0-13.0. The cleaner composition containing an alkaline agent, water, and as necessary, various additives can be used. Further, as the cleaner composition, compositions for alkali cleaning used generally in a production step of a glass substrate can be used as long as they satisfy the above-described pH range.

[Alkaline Agent]

The alkaline agent contained in the cleaner composition may be either an inorganic alkaline agent or an organic alkaline agent. Examples of the inorganic alkaline agents include ammonia, potassium hydroxide, sodium hydroxide and the like. At least one example of the organic alkaline agent is selected from the group consisting of hydroxyalkyl amine, tetramethyl ammonium hydroxide and choline. These alkaline agents may be used singly or as a mixture of two or more.

Examples of the hydroxyalkyl amine include monoethanolamine, diethanolamine, triethanolamine, methyl ethanolamine, methyl diethanolamine, monopropanolamine, dipropanolamine, tripropanolamine, methyl propanolamine, methyl dipropanolamine, aminoethyl ethanolamine and the like. Among these, in terms of enhancing the product stability and the environmental friendliness, monoethanolamine and methyl diethanolamine are preferred, and monoethanolamine is more preferred. These hydroxyalkyl amine may be used singly or as a mixture of two or more.

Among the above-described alkaline agents, in terms of enhancing the dispersibility of the cleaner composition with respect to residues on the substrate, enhancing the storage stability, and easiness in etching control with respect to glass in particular, at least one alkaline agent selected from the group consisting of potassium hydroxide, sodium hydroxide, monoethanolamine, methyldiethanolamine, and aminoethylethanolamine is preferred. Further preferred is at least one selected from the group consisting of potassium hydroxide and sodium hydroxide.

In terms of developing the cleaning property of the cleaner composition with respect to residues on the substrate, and enhancing the safety in operation, the content of the alkaline agent in the cleaner composition is preferably 0.1 to 10 wt %, and more preferably 0.3 to 3 wt %.

In terms of enhancing the residue dispersibility on the substrate, the pH of the cleaner composition is 8.0 to 13.0, preferably 9.0 to 13.0, more preferably 10.0 to 13.0, and further preferably 11.0 to 13.0. Incidentally, the above-described pH is a pH of the cleaner composition at 25° C., which can be measured using a pH meter (HM-30G manufactured by DKK-TOA CORPORATION) and indicates a numerical value taken 40 minutes after immersing an electrode in the cleaner composition.

[Various Additives]

Other than the alkaline agent, the cleaner composition may include a nonionic surfactant, a chelating agent, ether carboxylate, a fatty acid, an anionic surfactant, a water-soluble polymer, an antifoaming agent (excluding surfactants classified as the above-mentioned components), alcohols, an antiseptic agent, an antioxidizing agent, etc.

In terms of establishing a concentration for reducing cost and developing sufficient effects of various additives while enhancing storage stability, the content of the components other than water in the cleaner composition is preferably 10 to 60 wt %, more preferably 15 to 50 wt % and further preferably 15 to 40 wt % when the total of the water content and the contents of the other components is 100 wt %.

The cleaner composition is used after dilution. In consideration of the cleaning efficiency, the dilution rate is preferably 10 to 500-fold, more preferably 20 to 200-fold, and further preferably 50 to 100-fold. Water for dilution may be the same as those described below.

[Water]

Water contained in the cleaner composition is not particularly limited insofar as it can serve as a solvent, and the examples may be ultrapure water, pure water, ion exchange water, distilled water and the like. Ultrapure water, pure water and ion exchange water are preferable, and ultrapure water is more preferable. Pure water and ultrapure water can be obtained by, for example, passing tap water through activated carbon, followed by ion exchange treatment, distillation, and as necessary, irradiation using a specific ultraviolet germicidal lamp, or passing through a filter. Though the cleaner composition may further contain a water-based solvent (for example, alcohol such as ethanol) as a solvent in addition to water described above, it is preferable that the solvent contained in the cleaner composition is composed solely of water.

[Polishing Step of Glass Substrate]

The substrate producing method of the present invention includes a step of polishing a glass substrate to be polished using the above-described polishing composition (hereinafter, also referred to as “step (1)”). The substrate to be polished in the step (1) generally is a glass substrate after experiencing the fine-grinding step and preferably is a glass substrate after the rough-polishing step. The glass substrate is as described above. The step (1) can be performed by, for example, supplying the polishing composition on a surface of the glass substrate to be polished, bringing a polishing pad into contact with the surface, and moving the polishing pad and the substrate under a predetermined pressure (load). In terms of improving the final quality of the substrate, the step (1) is preferably a final-polishing step. Further, in the final-polishing step, it is preferable to perform a recirculation polishing using a polishing composition.

[Recirculation Polishing]

In the present specification, a recirculation polishing indicates a process of re-introducing polishing liquid that has been used in the step of polishing the glass substrate into a polisher and circulating the polishing liquid in the polisher so as to be reused. All of the liquid after the polishing may be recovered in a batch and introduced again into the polisher. Alternatively, the liquid after polishing may be introduced again into the polisher continuously while returning the liquid after polishing to the recovery tank. At the time of polishing the glass substrate with an acidic polishing composition, alkali metal ions contained in the glass substrate may be eluted. The inventors have found that since a pH of a polishing liquid will be raised due to the elusion of alkali ions, a polishing rate is decreased after a long time polishing. In that case, by using the acid in conjunction with the polyvalent amine compound, the buffer capacity is increased to suppress the lowering of the polishing rate, enabling the recirculation polishing for a longer time.

When the polishing composition is circulated in the polisher and reused, the number of the reuses is not limited in particular. The polishing composition is used suitably for polishing the glass hard disk substrate preferably 10 to 30 times, and more preferably 15 to 30 times. Further, in the present specification, as one embodiment, when circulating the polishing composition in the polisher for reuse, the recirculation polishing may include adding a new polishing composition into the polishing composition in the polisher stepwise or continuously. In the present embodiment, it is preferred that the new polishing composition is added so that the pH of the polishing composition in the polisher is adjusted in the range of 1.0 to 4.2, and preferably in the above-described pH range. Specifically, the amount of the polishing composition to be added newly is not particularly limited insofar as the pH is adjusted in the range of 1.0 to 4.2. However, in view of the productivity and continuity, the amount of the polishing composition to be added newly with respect to the amount of the polishing composition added circularly (the polishing composition to be added newly/the polishing composition added circularly) is preferably 0.005 to 1, and more preferably 0.01 to 0.8.

[Polishing Apparatus]

There is no particular limitation for a polishing apparatus used for polishing a glass substrate, and a polishing apparatus equipped with a jig (a carrier made of aramid, etc.) for holding a substrate to be polished and a polishing cloth (polishing pad) can be used. In particular, a both-side polishing apparatus is used preferably.

An example of the material for the polishing pad is an organic polymer, etc., and an example of the organic polymer is polyurethane or the like. Preferably the polishing pad is shaped like a nonwoven fabric. For example, a suede-like hard pad made of urethane is used preferably in the rough-polishing step, while in the final-polishing step, a suede-like soft pad made of urethane is used preferably.

A specific example of polishing using the polishing apparatus is as follows. A substrate to be polished is held by a carrier, sandwiched by a pair of polishing plates on which polishing pads are bonded. Then, the polishing composition is supplied between the polishing pads and the substrate, and the polishing plates and/or the substrate are moved under a predetermined pressure so as to polish the substrate while allowing the polishing composition to contact with the substrate.

In terms of improving the polishing rate, the polishing pressure in the step (1) is preferably 3 kPa or more, more preferably 4 kPa or more, further preferably 5 kPa or more, and further more preferably 6 kPa or more. In terms of polishing stability to prevent vibration in the polisher during the polishing, the polishing pressure is preferably 40 kPa or less, more preferably 30 kPa or less, further preferably 20 kPa or less, and further more preferably 15 kPa or less. Therefore, in terms of maintaining the polishing rate and polishing stably, the polishing pressure is preferably 3 to 40 kPa, more preferably 4 to 30 kPa, further preferably 5 to 20 kPa, and further more preferably 6 to 15 kPa. Here, “polishing pressure” indicates a pressure to be applied from the plates sandwiching the substrate to be polished to the surface to be polished of the substrate at the time of polishing.

Examples of the methods for supplying the polishing composition in the step (1) include a method of supplying the polishing composition whose components have been mixed sufficiently into the space between the polishing pads and the glass substrate by a pump, etc., a method of supplying after mixing the components in the supply line or the like just before the polishing, and a method of supplying the slurry of polishing abrasive grains and an aqueous solution containing the polyvalent amine compound separately into the polishing apparatus.

In terms of cost reduction, the supply rate of the polishing composition in the step (1) is preferably 1.0 mL/min. or less per square centimeter of the substrate to be polished, more preferably 0.6 mL/min. or less, and further preferably 0.4 mL/min. or less. For further improving the polishing rate, the supply rate is preferably 0.01 mL/min. or more per square centimeter of the substrate to be polished, more preferably 0.025 mL/min. or more, further preferably 0.05 mL/min. or more, and further more preferably 0.1 mL/min or more. Therefore, the supply rate is preferably 0.01 to 1.0 mL/min. per square centimeter of the substrate to be polished, more preferably 0.025 to 0.6 mL/min., further preferably 0.05 to 0.4 mL/min, and further more preferably 0.1 to 0.4 mL/min. In the case of recirculation polishing, as the polishing composition can be reused, the supply flow rate may be greater than the flow rate mentioned above. For further improving the polishing rate, the supply rate of the polishing composition in the recirculation polishing is preferably 0.1 mL/min. or more per square centimeter of the substrate to be polished, more preferably 0.2 mL/min. or more, and further preferably 0.3 mL/min. or more. In terms of cost reduction, the upper limit of the supply rate is preferably 3.0 mL/min. or less per square centimeter of the substrate to be polished, more preferably 2.5 mL/min. or less, and further preferably 2.2 mL/min. or less. Therefore, the supply rate in the recirculation polishing is preferably 0.1 to 3.0 mL/min. per square centimeter of the substrate to be polished, more preferably 0.2 to 2.5 mL/min., and further preferably 0.3 to 2.2 mL/min.

[Cleaning Step of Glass Substrate]

The substrate producing method of the present invention includes a step of cleaning the glass substrate (substrate to be cleaned) that have been polished using the above-described polishing composition, using the above-described cleaner composition (hereinafter, also referred to as step (2)). Examples of the substrate to be cleaned in the step (2) include a glass substrate directly after being subjected to the polishing in the step (1), and a glass substrate after experiencing the polishing in the step (1), followed by an immersing step into water or the like to prevent drying and an aqueous cleaning step or an acid cleaning step as a preliminary cleaning, etc. In the step (2), for example, the cleaner composition is supplied to the surface of the substrate to be cleaned by (a) immersing the substrate in the cleaner composition and/or (b) injecting the cleaner composition.

In the above-described method (a), conditions of immersing the substrate to be cleaned in the cleaner composition are not particularly limited, and for example, the temperature of the cleaner composition is preferably 20 to 100° C. in terms of safety and operability, and the immersion time is preferably 10 seconds to 30 minutes in terms of the cleaning property of the cleaner composition and production efficiency. In addition, in terms of enhancing residue removability and residue dispersibility, it is preferable to apply ultrasonic vibrations to the cleaner composition. The ultrasonic frequency is preferably 20 to 2000 kHz, more preferably 40 to 2000 kHz, and further preferably 40 to 1500 kHz.

In the above-described method (b), in terms of promoting residue cleaning property and oil dissolvability, it is preferable to clean the surface by bringing the cleaner composition into contact with the surface of the substrate to be cleaned by injecting the cleaner composition to which ultrasonic vibrations are applied, or to clean by injecting the cleaner composition onto the surface of the substrate to be cleaned and then by rubbing with a cleaning brush the surface provided with the cleaner composition. It is further preferable to clean by supplying the cleaner composition applied with ultrasonic vibrations to the surface of the object to be cleaned by injection and rubbing with a cleaning brush the surface provided with the cleaner composition.

A known means such as a spray nozzle or the like can be used as a means to supply the cleaner composition to a surface of a substrate to be cleaned. Moreover, a cleaning brush is not particularly limited, and for example, known brushes such as a nylon brush, a PVA (polyvinyl alcohol) sponge brush and the like can be used. It is sufficient that the ultrasonic frequency is represented by the same values as those preferably selected in the method (a) described above.

The step (2) may include, in addition to the above-described method (a) and/or the above-described method (b), one or more steps in which known cleaning such as swinging-cleaning, cleaning using the rotation of a spinner or the like, paddle cleaning, etc., is used.

### EXAMPLES

### Examples 1-18 and Comparative Examples 1-16

### 1. Preparation of Glass Substrate to be Polished

A glass substrate to be polished was prepared by roughly polishing an aluminosilicate glass substrate with a polishing composition containing ceria abrasive grains. Regarding constituent elements contained in the substrate, the Si content was 27 wt %, the Al content was 9 wt %, and the Na content was 6 wt %. The constituent elements were measured using ESCA method under the conditions below.

[Condition for ESCA Measurement]

Preparation of Specimen

An aluminosilicate glass substrate was cut into 1 cm×1 cm pieces, mounted on a double-sided tape made of carbon and fixed. For removing dusts or the like on the surface, Ar sputtering was applied for 6 minutes at an acceleration voltage of 2 kV so as to perform ESCA measurement.

Measurement

Equipment: PHI Quantera SXM manufactured by ULVAC-PHI, Inc.
X-ray source: monochromatic AlKα ray, 1486.6 eV, 25 W, 15 kV
Beam diameter: 100 μm
X-ray incident angle: 45°
Measurement range: 500×500 (μm²)
Pass energy: 280.0 (survey), 140.0 eV (narrow)
Step size: 1.00 (survey), 0.250 eV (narrow)
Measured elements: C, N, O, Na, Mg, Al, Si, S, K, Ti, Zr, Nb
Electrification correction: Neutralizer and Ar⁺ irradiation

### 2. Preparation of Polishing Composition

To ion-exchange water, a predetermined acid was added, and then, an additive (polyvalent amine compound) described below was added respectively in a ratio of 0.1 wt % in the polishing compositions of Examples 1-9, 11-13, 17, 18 and Comparative Examples 2-8, 13-16; 0.5 wt % in the polishing composition of Example 10; 0.005 wt % in the polishing composition of Example 14; 0.01 wt % in the polishing composition of Example 15; and 1 wt % in the polishing composition of Example 16. Further, colloidal silica (average particle diameter: 25 nm) was added so as to be 8 wt % in the polishing composition. The pH was adjusted at a predetermined value. Thus, the polishing compositions of Examples 1-18 and Comparative Examples 1-16 were obtained. Here, the used acids and the set pHs are as below.

[Acids]

Examples 1-9, 14-18: citric acid
Example 10: citric acid+sulfuric acid
Example 11: malic acid
Example 12: glycolic acid
Example 13: 1-hydroxyethylidene-1,1-diphosphonic acid (HEDP)
Comparative Examples 1-16: citric acid
[pH]

### Examples 1-8, 11-18: pH 3.0

### Example 9: pH 4.2

### Example 10: pH 1.5

### Comparative Examples 1-7, 9-16: pH 3.0

### Comparative Example 8: pH 4.5

### [Additive]

Example 1, Comparative Example 13: ethylenediamine (manufactured by Waco Pure Chemical Industries, Ltd.)
Example 2, Comparative Examples 8, 14: 2-[(2-aminoethyl)amino]ethanol (manufactured by Nippon Nyukazai Co., Ltd.)
Example 3: diethylenetriamine (manufactured by TOSOH CORPORATION)
Example 4: triethylenetetramine (manufactured by TOSOH CORPORATION)
Example 5: piperazine (manufactured by Waco Pure Chemical Industries, Ltd.)
Examples 6, 9-18, Comparative Example 15: 1-(2-hydroxyethyl)piperazine (manufactured by Nippon Nyukazai Co., Ltd.)
Example 7: 1-(2-aminoethyl)piperazine (manufactured by TOSOH CORPORATION)
Example 8, Comparative Example 16: tetraethylenepentamine (manufactured by TOSOH CORPORATION)

### Comparative Examples: 1, 9-12: None

Comparative Example 2: ethylamine (manufactured by Waco Pure Chemical Industries, Ltd.)
Comparative Example 3: monoethanolamine (manufactured by Sigma-Aldrich Co. LLC.)
Comparative Example 4: triethanolamine (manufactured by Sigma-Aldrich Co. LLC.)
Comparative Example 5: polyethyleneimine (SP-006 (molecular weight: 600), manufactured by NIPPON SHOKUBAI CO. LTD.)
Comparative Example 6: polydiallyldimethylammonium chloride (Merquat 100) (manufactured by NALCO COMPANY)
Comparative Example 7: acrylic acid/acrylamide-2-methylpropanesulfonic acid copolymer sodium salt (copolymer molar ratio: 89/11, weight average molecular weight: 2,000, manufactured by TOA GOSEI CO., LTD.)

The above-described acids were used so that the pH after blending would be adjusted to the objective pH. The used acids (additive amount of acids) were as follows. The content of the citric acid in the polishing composition was 1.1 to 1.8 wt % in Examples 1-8, 17, 18 and Comparative Examples 2-6, 13-16; the content of the citric acid was 0.41 wt % in Example 9; the content of the sulfuric acid was 0.6 wt % and the content of the citric acid was 1.0 wt % in Example 10; the content of the malic acid was 1.24 wt % in Example 11; the content of the glycolic acid was 1.25 wt % in Example 12; the content of the HEDP was 0.38 wt % in Example 13; the content of the citric acid was 0.70 wt % in Example 14; the content of the citric acid was 0.74 wt % in Example 15; the content of the citric acid was 5.1 wt % in Example 16; the content of the citric acid was 0.65 wt % in Comparative Examples 1 and 9; the content of the citric acid was 0.88 wt % in Comparative Example 7; the content of the citric acid was 0.40 wt % in Comparative Example 8; the content of the citric acid was 0.65 wt % in Comparative Example 10; the content of the citric acid was 0.65 wt % in Comparative Example 11; and the content of the citric acid was 0.65 wt % in Comparative Example 12.

[Method for Measuring Average Primary Particle Diameter of Silica Particles]

A specimen including colloidal silica was observed with a transmission electron microscope “JEM-2000FX” (80 kV, 10000-50000X manufactured by JEOL Ltd.) in accordance with instructions attached to the microscope by the manufacturer, and the TEM (Transmission Electron Microscope) images were photographed. The photographed images were scanned by using a scanner into a personal computer as image data. Then, the diameter of a circle having the same area as that of each silica particle was measured to obtain the particle diameter with analysis software “WinROOF ver. 3.6” (commercially available from Mitani Corporation). In this manner, particle diameters for 1000 silica particles were obtained and subsequently the average value was calculated to obtain the average primary particle diameter.

### 3. Polishing Method

Polishing with the polishing compositions of Examples 1-16 and Comparative Examples 1-8 and 10-16 was carried out under the conditions for a standard polishing test below.

### [Polishing Condition]

Polishing test machine: “double-sided 9B polisher” manufactured by Speedfam Co., Ltd.
Polishing pad: suede type (thickness: 0.9 mm, average pore diameter: 30 μm)
Supply amount of polishing composition: 100 mL/min. (supply rate per square centimeter of a substrate to be polished: about 0.3 mL/min.)
Number of revolutions of the lower plate: 32.5 rpm
Polishing pressure: 8.4 kPa
Carrier: made of aramid having a thickness of 0.45 mm
Polishing time: 20 minutes
Substrate to be polished: aluminosilicate glass substrate (outer diameter: 65 mm, inner diameter: 20 mm, thickness: 0.635 mm)
Number of substrates inserted'. 10
Rinse condition: pressure=2.0 kPa, time=2 minutes, ion-exchange water supply amount=about 2 L/min.
The substrates after polishing were cleaned under the cleaning conditions below for evaluations.

Recirculation polishing using the polishing compositions of Examples 17, 18 and Comparative Example 9 was carried out under the conditions for a polishing test below.

### [Polishing Condition]

Polishing test machine: “double-sided 9B polisher” manufactured by Speedfam Co., Ltd.
Polishing pad: suede type (thickness: 0.9 mm, average pore diameter: 30 μm)
Supply amount of polishing composition: 100 mL/min. (supply rate per square centimeter of a substrate to be polished: about 0.3 mL/min.)
Number of revolutions of the lower plate: 32.5 rpm
Polishing pressure: 8.4 kPa
Carrier: made of aramid having a thickness of 0.45 mm
Polishing time: 20 minutes
Substrate to be polished: aluminosilicate glass substrate (outer diameter: 65 mm, inner diameter: 20 mm, thickness: 0.635 mm)
Number of substrates inserted: 10
Rinse condition: pressure=2.0 kPa, time=2 minutes, ion-exchange water supply amount=about 2 L/min.
Number of recirculation batches: 15 batches
Amount of polishing liquid: 2 L
Method of recirculation polishing: polishing liquid was supplied from a container of the polishing liquid at a flow rate of 100 mL/min., and polishing was performed while returning the polishing liquid after polishing discharged from a drain to the container of the polishing liquid.
The substrates of 15th batch of the recirculation polishing were cleaned under the cleaning conditions below for evaluations.
In Example 18, during polishing, a new polishing liquid of 100 ml was added per 5 minutes into the container of the polishing liquid. The pH during polishing was between 3.0 to 3.5.

### 4. Cleaning Method

Each of the polished aluminosilicate glass substrates was cleaned using a cleaning apparatus under the conditions below.

(1) Cleaning-1: Immerse a substrate to be cleaned into a resin tank (40° C.) containing one of cleaning liquids 1-5 mentioned below, and clean the substrate for 120 seconds while irradiating the substrate with ultrasonic wave.
Cleaning agent 1: (Examples 1-18, Comparative Examples 1-9), an alkaline cleaner composition of pH 12.0 composed of a KOH aqueous solution
Cleaning agent 2: (Comparative Example 10), an alkaline cleaner composition obtained by adding 0.1% 2-[(2-aminoethyl)amino]ethanol (manufactured by Nippon Nyukazai Co., Ltd.) to the cleaning agent 1 and adjusting the pH at 12.0 using a KOH aqueous solution
Cleaning agent 3: (Comparative Example 11), an alkaline cleaner composition obtained by adding 0.1% 1-(2-hydroxyethyl)piperazine (manufactured by Nippon Nyukazai Co., Ltd.) to the cleaning agent 1 and adjusting the pH at 12.0 using a KOH aqueous solution
Cleaning agent 4: (Comparative Example 12), an alkaline cleaner composition obtained by adding 0.1% tetraethylenepentamine (manufactured by TOSOH CORPORATION) to the cleaning agent 1 and adjusting the pH at 12.0 using a KOH aqueous solution
Cleaning agent 5: (Comparative Examples 13-16), an acidic cleaner composition of pH 2.5 prepared using 1-hydroxyethylidene-1,1-diphosphonic acid (HEDP)
(2) Rinsing-1: Move the substrate to be cleaned into a resin tank containing ultrapure water (40° C.), and rinse for 120 seconds while irradiating with ultrasonic wave.

### (3) Repeat (1) and (2).

(4) Cleaning-2: Move the substrate to be cleaned from the interior of the resin tank into a scrub-cleaning unit equipped with cleaning brushes. Inject the cleaner composition at room temperature toward the cleaning brushes and conduct a cleaning for 5 seconds by pressing the cleaning brushes onto the both surfaces of the substrate while rotating the brushes at 400 rpm under presence of the cleaner composition. For the cleaner composition, the same make-up as the cleaner composition used in “(1) Cleaning-1” is used.
(5) Rinsing-2: Move the substrate to be cleaned into a subsequent scrub-cleaning unit, inject ultrapure water at room temperature, and conduct rinsing for 5 seconds by pressing cleaning brushes onto the both surfaces of the substrate while rotating the brushes at 400 rpm.

### (6) Repeat (4) and (5).

(7) Rinsing-3: Move the substrate into a resin tank containing ultrapure water and conduct rinsing for 10 minutes.
(8) Drying: Move the substrate into a resin tank containing warm pure water (60° C.) and immerse for 60 seconds. Thereafter, pull out the substrate to be cleaned at a rate of 250 mm/min. and leave for 420 seconds so as to dry the substrate surfaces completely.

### 5. Evaluation Method

Evaluations on the polishing rate, surface roughness, substrate cleanliness and amine odor were carried out in the following manner.

[Method for Measuring Polishing Rate]

The weight difference (g) of the substrate before and after polishing was divided with the density of the substrate (2.46 g/cm³), surface area of the substrate (30.04 cm²) and the polishing time (minute) in order to calculate a polishing amount per unit time, thereby calculating a polishing rate (μm/min.). The result is shown in Tables 1 and 2 below as a relative value when the value in Comparative Example 1 is identified as 100.

[Method for Measuring Surface Roughness]

From ten substrates that have been subjected to the same polishing treatment obtained from the above-described polishing method, two sets of four substrates were selected at random. The respective substrates were subjected to aqueous cleaning without using the cleaner composition and alkali cleaning using the cleaner composition, so as to measure respective surface roughness. The surface roughness was obtained by measuring both surfaces of the respective substrates under the conditions mentioned below using an AFM (Digital Instrument NanoScope IIIa Multi Mode AFM) and averaging the values. Further, the surface roughness of the substrate after alkali cleaning was divided with the surface roughness of the substrate after aqueous cleaning so as to calculate a deterioration rate of the surface roughness due to alkali cleaning. These results are shown in Tables 1-3 below.

(Measurement conditions of AFM)
Mode: Tapping mode

### Area: 1×1 μm

Scan rate: 1.0 Hz

### Cantilever: NCH-10V

### Line: 512×512

[Evaluation of Substrate Cleanliness: Method for Measuring Residual Particles]

After polishing, cleaning and drying a glass hard disk substrate, the number of particles remaining on the substrates was measured by the method mentioned below.

Measuring instrument: OSA7100 manufactured by KLA Tencor Corporation
Evaluation: From ten substrates polished by the above-described polishing method, four substrates were selected at random. Each substrate was irradiated with laser beam at 10000 rpm so as to measure protrusion defects. The total number of the protrusion defects on both surfaces of each of the four substrates were divided with 8 to calculate the number as the particle number per substrate surface. The results are shown in Tables 1-3 below, as a relative value when the value in Comparative Example 1 is identified as 100.

[Evaluation of Amine Odor]

Regarding the respective polishing compositions indicated in Table 1, the amine odor was evaluated under the room-temperature conditions in accordance with the evaluation criteria below by a sensory evaluation by three panelists.

[Evaluation criteria]
N: substantially no amine odor
D: amine odor exists

Table 1 below collectively shows results of Examples 1-18 and Comparative Examples 1-9. Example 17, 18 and Comparative Example 9 are results of the recirculation polishing. As described above, Example 18 is an example where a new polishing liquid of 100 ml was added per 5 minutes into the container of the polishing liquid during recirculation polishing.

TABLE 1

| | | | | | | | | Roughness | |
|---|---|---|---|---|---|---|---|---|---|
| | | | | Number | | | | after | |
| | | | | of N | Polishing | | Additive | aqueous | Cleaning |
| | | | | atoms in | agent | Molecular | amount | cleaning | agent |
| | | Additive | Add type | molecule | pH | weight | [%] | [Å] | pH |
| Ex | 1 | ethylenediamine | citric acid | 2 | 3.0 | 60 | 0.1 | 0.83 | 12.0 |
| | 2 | 2-[(2-aminoethyl)amino]ethanol | citric acid | 2 | 3.0 | 104 | 0.1 | 0.83 | 12.0 |
| | 3 | diethylenetriamine | citric acid | 3 | 3.0 | 103 | 0.1 | 0.88 | 12.0 |
| | 4 | triethylenetetramine | citric acid | 4 | 3.0 | 146 | 0.1 | 0.85 | 12.0 |
| | 5 | piperazine | citric acid | 2 | 3.0 | 86 | 0.1 | 0.83 | 12.0 |
| | 6 | 1-(2-hydroxyethyl)piperazine | citric acid | 2 | 3.0 | 130 | 0.1 | 0.79 | 12.0 |
| | 7 | 1-(2-aminoethyl)piperazine | citric acid | 3 | 3.0 | 129 | 0.1 | 0.81 | 12.0 |
| | 8 | tetraethylenepentamine | citric acid | 5 | 3.0 | 189 | 0.1 | 0.81 | 12.0 |
| | 9 | 1-(2-hydroxyethyl)piperazine | citric acid | 2 | 4..2 | 130 | 0.1 | 0.81 | 12.0 |
| | 10 | 1-(2-hydroxyethyl)piperazine | citric acid + | 2 | 1.5 | 130 | 0.5 | 0.93 | 12.0 |
| | | | sulfuric | | | | | | |
| | | | acid | | | | | | |
| | 11 | 1-(2-hydroxyethyl)piperazine | malic acid | 2 | 3.0 | 130 | 0.1 | 0.83 | 12.0 |
| | 12 | 1-(2-hydroxyethyl)piperazine | glycolic | 2 | 3.0 | 130 | 0.1 | 0.84 | 12.0 |
| | | | acid | | | | | | |
| | 13 | 1-(2-hydroxyethyl)piperazine | HEDP | 2 | 3.0 | 130 | 0.1 | 0.81 | 12.0 |
| | 14 | 1-(2-hydroxyethyl)piperazine | citric acid | 2 | 3.0 | 130 | 0.005 | 0.84 | 12.0 |
| | 15 | 1-(2-hydroxyethyl)piperazine | citric acid | 2 | 3.0 | 130 | 0.01 | 0.84 | 12.0 |
| | 16 | 1-(2-hydroxyethyl)piperazine | citric acid | 2 | 3.0 | 130 | 1 | 0.76 | 12.0 |
| Comp. | 1 | None | citric acid | — | 3.0 | — | — | 0.95 | 12.0 |
| Ex | 2 | ethylamine | citric acid | 1 | 3.0 | 45 | 0.1 | 0.89 | 12.0 |
| | 3 | monoethanolamine | citric acid | 1 | 3.0 | 61 | 0.1 | 0.9 | 12.0 |
| | 4 | triethanolamine | citric acid | 1 | 3.0 | 149 | 0.1 | 0.89 | 12.0 |
| | 5 | polyethyleneimine | citric acid | abt. 14 | 3.0 | 600 | 0.1 | 0.83 | 12.0 |
| | 6 | polydiallyldimethylammonium | citric acid | abt. 1300 | 3.0 | 150000 | 0.1 | 0.78 | 12.0 |
| | | chloride | | | | | | | |
| | 7 | acrylic acid/acrylamide-2- | citric acid | abt. 1 | 3.0 | 2000 | 0.1 | 0.90 | 12.0 |
| | | methyl-propanesulfonic | | | | | | | |
| | | acid copolymer sodium salt | | | | | | | |
| | 8 | 2-[(2-aminoethyl)amino]ethanol | citric acid | 2 | 4.5 | 104 | 0.1 | 0.80 | 12.0 |
| Ex | 17 | 1-(2-hydroxyethyl)piperazine | citric acid | 2 | 3.0 | 130 | 0.1 | 0.80 | 12.0 |
| Ex | 18 | 1-(2-hydroxyethyl)piperazine | citric acid | 2 | 3.0 | 130 | 0.1 | 0.77 | 12.0 |
| Comp. | 9 | None | citric acid | — | 3.0 | — | — | 0.97 | 12.0 |
| Ex | | | | | | | | | |

| | | | Roughness | | | | |
|---|---|---|---|---|---|---|---|
| | | | after | | Polishing | | |
| | | | alkali | Deterioration | rate | Cleanliness | |
| | | | cleaning | rate of | [relative | [relative | Amine |
| | | Additive | [Å] | roughness | value] | value] | odor |
| Ex | 1 | ethylenediamine | 0.86 | 1.04 | 98 | 63 | D |
| | 2 | 2-[(2-aminoethyl)amino]ethanol | 0.84 | 1.01 | 95 | 57 | N |
| | 3 | diethylenetriamine | 0.92 | 1.05 | 97 | 57 | N |
| | 4 | triethylenetetramine | 0.87 | 1.02 | 96 | 55 | N |
| | 5 | piperazine | 0.89 | 1.07 | 98 | 60 | N |
| | 6 | 1-(2-hydroxyethyl)piperazine | 0.81 | 1.03 | 99 | 61 | N |
| | 7 | 1-(2-aminoethyl)piperazine | 0.83 | 1.02 | 95 | 56 | N |
| | 8 | tetraethylenepentamine | 0.83 | 1.02 | 87 | 51 | N |
| | 9 | 1-(2-hydroxyethyl)piperazine | 0.82 | 1.01 | 89 | 51 | N |
| | 10 | 1-(2-hydroxyethyl)piperazine | 1.01 | 1.09 | 106 | 49 | N |
| | 11 | 1-(2-hydroxyethyl)piperazine | 0.85 | 1.02 | 99 | 52 | N |
| | 12 | 1-(2-hydroxyethyl)piperazine | 0.86 | 1.02 | 99 | 51 | N |
| | 13 | 1-(2-hydroxyethyl)piperazine | 0.83 | 1.02 | 95 | 54 | N |
| | 14 | 1-(2-hydroxyethyl)piperazine | 0.87 | 1.04 | 100 | 80 | N |
| | 15 | 1-(2-hydroxyethyl)piperazine | 0.86 | 1.02 | 100 | 63 | N |
| | 16 | 1-(2-hydroxyethyl)piperazine | 0.79 | 1.04 | 91 | 70 | N |
| Comp. | 1 | None | 1.13 | 1.19 | 100 | 100 | N |
| Ex | 2 | ethylamine | 1 | 1.12 | 98 | 83 | D |
| | 3 | monoethanolamine | 0.99 | 1.10 | 95 | 86 | D |
| | 4 | triethanolamine | 0.98 | 1.10 | 98 | 88 | D |
| | 5 | polyethyleneimine | 0.89 | 1.07 | 58 | 50 | N |
| | 6 | polydiallyldimethylammonium | 0.82 | 1.05 | 62 | 53 | N |
| | | chloride | | | | | |
| | 7 | acrylic acid/acrylamide-2- | 1.03 | 1.14 | 86 | 85 | N |
| | | methyl-propanesulfonic | | | | | |
| | | acid copolymer sodium salt | | | | | |
| | 8 | 2-[(2-aminoethyl)amino]ethanol | 0.81 | 1.01 | 80 | 65 | N |
| Ex | 17 | 1-(2-hydroxyethyl)piperazine | 0.83 | 1.04 | 94 | 65 | N |
| Ex | 18 | 1-(2-hydroxyethyl)piperazine | 0.79 | 1.03 | 97 | 51 | N |
| Comp. | 9 | None | 1.16 | 1.20 | 88 | 105 | N |
| Ex | | | | | | | |

As shown in Table 1 above, Examples 1-16 exhibited superior polishing rates, surface roughness and cleanliness as compared with those of Comparative Examples 1-8. Further, Examples 17 and 18, in which the recirculation polishing was performed, exhibited superior polishing rates, surface roughness and cleanliness as compared with those of Comparative Example 9, and proved that the effects sustained also in the recirculation polishing.

Table 2 below collectively shows results of Comparative Examples 10-12, together with the results of Examples 2, 6, 8 and Comparative Example 1 in Table 1. Further, Table 3 below collectively shows results of Comparative Examples 13-16, together with the results of Examples 1, 2, 6 and 8 in Table 1.

TABLE 2

| | | | Roughness | | | Roughness | | | |
|---|---|---|---|---|---|---|---|---|---|
| | | | after | | | after | | Polishing | |
| | | Polishing | aqueous | | Cleaning | alkali | Deterioration | rate | Cleanliness |
| | Additive added to | agent | cleaning | Additive added to | agent | cleaning | rate of | [relative | [relative |
| | polishing composition | pH | [Å] | cleaning agent | pH | [Å] | roughness | value] | value] |
| Ex 2 | 2-[(2-aminoethyl)amino] | 3.0 | 0.83 | None | 12.0 | 0.84 | 1.01 | 95 | 57 |
| | ethanol | | | | | | | | |
| Ex 6 | 1-(2-hydroxyethyl) | 3.0 | 0.79 | None | 12.0 | 0.81 | 1.03 | 99 | 61 |
| | piperazine | | | | | | | | |
| Ex 8 | tetraethylenepentamine | 3.0 | 0.81 | None | 12.0 | 0.83 | 1.02 | 87 | 51 |
| Comp. | None | 3.0 | 0.95 | None | 12.0 | 1.13 | 1.19 | 100 | 100 |
| Ex 1 | | | | | | | | | |
| Comp. | None | 3.0 | | 2-[(2-aminoethyl)amino] | 12.0 | 1.08 | 1.13 | | 112 |
| Ex 10 | | | | ethanol | | | | | |
| Comp. | None | 3.0 | | 1-(2-hydroxyethyl) | 12.0 | 1.13 | 1.19 | | 67 |
| Ex 11 | | | | piperazine | | | | | |
| Comp. | None | 3.0 | | tetraethylenepentamine | 12.0 | 1.09 | 1.14 | | 51 |
| Ex 12 | | | | | | | | | |

TABLE 3

| | | | Roughness | | | | |
|---|---|---|---|---|---|---|---|
| | | | after | | Roughness | | |
| | | Polishing | aqueous | Cleaning | after | Deterioration | Cleanliness |
| | | agent | cleaning | agent | cleaning | rate of | [relative |
| | Additive | pH | [Å] | pH | [Å] | roughness | value] |
| Ex 1 | ethylenediamine | 3.0 | 0.83 | 12.0 | 0.86 | 1.04 | 63 |
| Comp. | ethylenediamine | 3.0 | 0.83 | 2.5 | 0.84 | 1.01 | 161 |
| Ex 13 | | | | | | | |
| Ex 2 | 2-[(2-aminoethyl)amino]ethanol | 3.0 | 0.83 | 12.0 | 0.84 | 1.01 | 57 |
| Comp. | 2-[(2-aminoethyl)amino]ethanol | 3.0 | 0.83 | 2.5 | 0.83 | 1.00 | 123 |
| Ex 14 | | | | | | | |
| Ex 6 | 1-(2-hydroxyethyl)piperazine | 3.0 | 0.79 | 12.0 | 0.81 | 1.03 | 61 |
| Comp. | 1-(2-hydroxyethyl)piperazine | 3.0 | 0.79 | 2.5 | 0.80 | 1.01 | 145 |
| Ex 15 | | | | | | | |
| Ex 8 | tetraethylenepentamine | 3.0 | 0.81 | 12.0 | 0.83 | 1.02 | 51 |
| Comp. | tetraethylenepentamine | 3.0 | 0.81 | 2.5 | 0.82 | 1.01 | 112 |
| Ex 16 | | | | | | | |

As shown in Table 2 above, Examples 2, 6 and 8 exhibited superior surface roughness and cleanliness as compared with those of Comparative Examples 1 and 10-12. In Comparative Examples 10-12, additives of polishing agents in Examples 2, 6 and 8 were added respectively to cleaning agents, not to polishing agents. Further, as shown in Table 3 above, Example 1 exhibited superior cleanliness as compared with that of Comparative Example 13, Example 2 exhibited superior cleanliness as compared with that of Comparative Example 14, Example 6 exhibited superior cleanliness as compared with that of Comparative Example 15, and Example 8 exhibited superior cleanliness as compared with that of Comparative Example 16.

The above Tables 2 and 3 demonstrate that, when the cleaning agent is not an alkaline cleaning agent but an acidic cleaning agent, and a polyvalent amine compound is added not to a polishing composition but to an alkaline cleaning agent, etc., it is impossible to obtain effects comparable to excellent effects (superior polishing rate, surface roughness and cleanliness) of the present invention obtained by: polishing a glass substrate with an acidic polishing composition containing a polyvalent amine compound; and cleaning the substrate with an alkaline cleaner composition.

### INDUSTRIAL APPLICABILITY

According to the substrate producing method of the present invention, it is possible to provide a method for producing a glass hard disk substrate capable of effectively inhibiting degradation of surface roughness of the glass substrate in an alkali cleaning step while obtaining a high polishing rate in a polishing step. Therefore, the substrate producing method of the present invention is useful in production of a glass hard disk substrate.

The present invention may relate to any of the following:

<1> A method for producing a glass hard disk substrate that includes the following steps (1) and (2):

(1) polishing a glass substrate to be polished using a polishing composition of pH 1.0-4.2 that contains a polyvalent amine compound having 2 to 10 nitrogen atoms in the molecule; and

(2) cleaning the substrate obtained in the step (1) using a cleaner composition of pH 8.0-13.0;

<2> The method for producing a glass hard disk substrate according to <1>, wherein a molecular weight of the polyvalent amine compound is 500 or less;

<3> The method for producing a glass hard disk substrate according to <1> or <2>, wherein the number of nitrogen atoms contained in the polyvalent amine compound is 8 or less, preferably 6 or less, more preferably 5 or less, and further preferably 4 or less, or, 2 to 8, preferably 2 to 6, more preferably 2 to 5, and further preferably 2 to 4;

<4> The method for producing a glass hard disk substrate according to any one of <1> to <3>, wherein a molecular weight of the polyvalent amine compound is 500 or less, preferably 400 or less, more preferably 300 or less, and further preferably 200 or less, or, 40 or more, preferably 50 or more, more preferably 60 or more, further preferably 100 or more, and further more preferably 150 or more, or, 40 to 500, preferably 50 to 500, further preferably 50 to 400, further more preferably 60 to 300, further more preferably 100 to 300, and further more preferably 150 to 200;

<5> The method for producing a glass hard disk substrate according to any one of <1> to <4>, wherein the content of the polyvalent amine compound is 5 wt % or less, preferably 4 wt % or less, more preferably 3 wt % or less, further preferably 1 wt % or less, further more preferably 0.5 wt % or less, and further more preferably 0.1 wt % or less, or, 0.001 wt % or more, preferably 0.005 wt % or more, and more preferably 0.01 wt % or more, or, 0.001 to 5 wt %, preferably 0.005 to 4 wt %, more preferably 0.01 to 3 wt %, further preferably 0.01 to 1 wt %, further more preferably 0.01 to 0.5 wt %, and further more preferably 0.01 to 0.1 wt %.

<6> The method for producing a glass hard disk substrate according to any one of <1> to <5>, wherein the glass substrate to be polished is a glass substrate made of glass that contains metallic atoms other than Si;

<7> The method for producing a glass hard disk substrate according to any one of <1> to <6>, wherein the glass substrate to be polished is a glass substrate of aluminosilicate glass, borosilicate glass, aluminoborosilicate glass, or aluminosilicate glass whose sodium is substituted by potassium in a chemical strengthening step;

<8> The method for producing a glass hard disk substrate according to any one of <1> to <7>, wherein the glass substrate to be polished is an aluminosilicate glass substrate;

<9> The method for producing a glass hard disk substrate according to any one of <1> to <8>, wherein the polishing composition further contains at least one kind of acids selected from polyvalent carboxylic acids, phosphorous inorganic acids, and phosphorous organic acids;

<10> The method for producing a glass hard disk substrate according to <9>, wherein the content of the acid in the polishing composition is 0.05 wt % or more, preferably 0.1 wt % or more, and more preferably 0.15 wt % or more, or, 10 wt % or less, preferably 7.5 wt % or less, more preferably 5.5 wt % or less, and further preferably 2 wt % or less, or, 0.05 to 10 wt %, preferably 0.1 to 7.5 wt %, more preferably 0.15 to 5.5 wt %, and further preferably 0.15 to 2 wt %;

<11> The method for producing a glass hard disk substrate according to <9> or <10>, wherein the weight ratio of the polyvalent amine compound to the acid (polyvalent amine compound weight/acid weight) in the polishing composition is 0.001 to 1.0, preferably 0.005 to 0.5, and more preferably 0.01 to 0.3;

<12> The method for producing a glass hard disk substrate according to any one of <1> to <11>, wherein the polishing composition contains silica as a polishing abrasive grain;

<13> The method for producing a glass hard disk substrate according to any one of <1> to <12>, wherein the content of the polishing abrasive grain in the polishing composition is 1 to 20 wt %, preferably 2 to 19 wt %, more preferably 3 to 18 wt %, and further preferably 5 to 16 wt %;

<14> The method for producing a glass hard disk substrate according to any one of <1> to <13>, wherein the pH of the polishing composition is 1.0 to less than 4.2, preferably 1.5 to 4.0, more preferably 1.5 to 3.5, further preferably 2.0 to 3.5, and further more preferably 2.5 to 3.5;

<15> The method for producing a glass hard disk substrate according to any one of <1> to <14>, wherein the pH of the cleaner composition is 9.0 to 13.0, preferably 10.0 to 13.0, and more preferably 11.0 to 13.0;

<16> The method for producing a glass hard disk substrate according to any one of <1> to <15>, wherein the step (1) includes a recirculation polishing step;

<17> The method for producing a glass hard disk substrate according to <16>, wherein the recirculation polishing step includes adjusting the pH of the polishing composition used in recirculation polishing at 1.0 to 4.2 by supplying a new polishing composition;

<18> The method for producing a glass hard disk substrate according to any one of <1> to <17>, wherein the polishing pressure in the step (1) is 3 kPa or more, preferably 4 kPa or more, more preferably 5 kPa or more, and further preferably 6 kPa or more, or, 40 kPa or less, preferably 30 kPa or less, more preferably 20 kPa or less, and further preferably 15 kPa or less, or, 3 to 40 kPa, preferably 4 to 30 kPa, more preferably 5 to 20 kPa, and further preferably 6 to 15 kPa;

<19> The method for producing a glass hard disk substrate according to any one of <1> to <18>, wherein the supply rate of the polishing composition in the step (1) is 1.0 mL/min. or less per square centimeter of the substrate to be polished, preferably 0.6 mL/min. or less, and further preferably 0.4 mL/min. or less, or, 0.01 mL/min. or more per square centimeter of the substrate to be polished, preferably 0.025 mL/min. or more, more preferably 0.05 mL/min. or more, and further preferably 0.1 mL/min. or more, or, 0.01 to 1.0 mL/min. per square centimeter of the substrate to be polished, preferably 0.025 to 0.6 mL/min., more preferably 0.05 to 0.4 mL/min, and further preferably 0.1 to 0.4 mL/min; and

<20> The method for producing a glass hard disk substrate according to any one of <1> to <19>, wherein the step (1) includes a recirculation polishing step, and the supply rate of the polishing composition in the step (1) is 0.1 mL/min. or more per square centimeter of the substrate to be polished, preferably 0.2 mL/min. or more, and more preferably 0.3 mL/min. or more, or, 3.0 mL/min. or less per square centimeter of the substrate to be polished, preferably 2.5 mL/min. or less, and more preferably 2.2 mL/min. or less, or, 0.1 to 3.0 mL/min. per square centimeter of the substrate to be polished, preferably 0.2 to 2.5 mL/min., and more preferably 0.3 to 2.2 mL/min.

1. A method for producing a glass hard disk substrate, comprising the following steps (1) and (2):
(1) polishing a glass substrate to be polished using a polishing composition of pH 1.0-4.2 that contains a polyvalent amine compound having 2 to 10 nitrogen atoms in the molecule; and
(2) cleaning the substrate obtained in the step (1) using a cleaner composition of pH 8.0-13.0.

2. The method for producing a glass hard disk substrate according to claim 1, wherein a molecular weight of the polyvalent amine compound is 500 or less.

3. The method for producing a glass hard disk substrate according to claim 1, wherein the glass substrate to be polished is an aluminosilicate glass substrate.

4. The method for producing a glass hard disk substrate according to claim 1, wherein the polishing composition further contains at least one kind of acids selected from polyvalent carboxylic acids, phosphorous inorganic acids, and phosphorous organic acids.

5. The method for producing a glass hard disk substrate according to claim 1, wherein the polishing composition contains silica.

6. The method for producing a glass hard disk substrate according to claim 1, wherein the step (1) includes a recirculation polishing step.

7. The method for producing a glass hard disk substrate according to claim 6, wherein the recirculation polishing step includes adjusting a pH of a polishing composition used in recirculation polishing at 1.0 to 4.2 by supplying a new polishing composition.
